(19) United States
(12) Patent Application Publication
(10) Pub. No.: US 2026/0041105 A1
(43) Pub. Date: Feb. 12, 2026

(54) ANIMAL STUNNING ENCLOSURE

(71) Applicant: Jarvis Products Corporation, Middletown, CT (US)

(72) Inventor: Robert Haworth, Richlands (AU)

(21) Appl. No.: 19/125,584

(22) PCT Filed: Dec. 15, 2022
(86) PCT No.: PCT/US2022/053022

§ 371 Date: Apr. 29, 2025

Related U.S. Application Data
(60) Provisional application No. 63/384,670, filed on Nov. 22, 2022.

(51) Int. Cl. A22B 3/06; A22B 1/00; A22B 5/02

(52) U.S. Cl. CPC A22B 3/06; A22B 1/00; A22B 5/02

(57) ABSTRACT

An enclosure for stunning animals for use in livestock/slaughterhouse operations comprising an animal-supporting floor, a plurality of upward-extending sidewalls around the floor to enclose an animal before and during stunning, and a moveable stunner mount for securing an electrical or pneumatic stunner. The enclosure comprises a second moveable stunner mount for securing a second stunner such that a single enclosure may be used for both electrical or percussive stunning operations. One or more moveable panels may be used to secure the animal within the enclosure. After moving the animal into the enclosure and securing the animal head in a position to be stunned, the animal may be stunned via an electrical or pneumatic stunner, and the animal carcass may be removed from the enclosure. The enclosure may utilize a control system having a computer program code to carry out stunning operations.

### BACKGROUND OF THE INVENTION

### 1. Field of the Invention

The present invention relates to an enclosure for stunning animals, for example, cows and other cattle, for use in livestock/slaughterhouse operations.

### 2. Description of Related Art

In livestock production plants, it is important to stun and kill an animal, for example cows and other cattle, in a humane manner for processing. Numerous methods have been used to stun livestock, for example electric stunners and percussive stunners, the latter including pneumatically-powered captive bolt mechanisms. Production plants may present animals on a movable conveyor strip or in a separate enclosure, with a stunner station disposed at some point along the conveyor's path or in the enclosure. Ideally, an animal is stunned as it moves through the stunner station via the conveyor. Proper and effective stunning procedures require the animal to be in a calm state before and during the time of stunning and the animal's head to be accessible by the stunner and presented in a manner so that death occurs as quickly as possible and with certainty.

It has been found that conventional steel enclosures are noisy to operate as a result of the animals moving and kicking the walls and vocalizing, which agitates the animal in the enclosure as well as the animals waiting to enter the enclosure. It has also been found that improper restraints can place excessive force and crush the animal's back and/or neck, causing unnecessary pain before stunning. In the case of electric stunning, there has been found to be current leakage by the animal grounding itself against the walls so that full current does not flow in the proper direction which also causes excessive pain. In all types of stunning, it has been found that the animal's weight is important to consider to optimize the stunner action, which traditional enclosures do not consider. Following stunning, traditional enclosures also may not dispose of the animal's body in a manner conducive to subsequent processing of the carcass and quality of the meat.

A need exists for an improved stunner enclosure which does not preemptively agitate and alert the animal to be stunned so as to cause the animal to move its body or raise its head to a position which causes pain to the animal or prevents proper and humane administration of the stunning to instantly achieve disabling of the animal. A need also exists for an improved stunner enclosure which efficiently monitors and controls the entire stunning process, including monitoring of animal weight to collect data for improvement of the stunning process, and which efficiently disposes of the carcass after stunning without unnecessarily bruising the carcass and adversely affecting the quality of the meat and operator safety throughout the process.

### SUMMARY OF THE INVENTION

Bearing in mind the problems and deficiencies of the prior art, it is therefore an object of the present invention to provide an animal stunning enclosure which reduces the agitation and movement of an animal within the enclosure prior to the stunning operation of the animal stunning enclosure.

It is another object of the present invention to provide an animal stunning enclosure which facilitates a proper and humane administration of animal stunning while simultaneously reducing the risk of pain or improper stunning of the animal within the enclosure.

A further object of the present invention is to provide an animal stunning enclosure which can efficiently monitor and control the entire stunning process.

Still, another object of the present invention is to provide an animal stunning enclosure which can monitor animal weight and collect data to improve the stunning process.

It is another object of the present invention to provide an efficient disposal of the animal carcass after stunning without causing unnecessary bruising carcass or adversely affecting the quality of the meat.

It is yet another object of the present invention to provide a safe and efficient animal stunning enclosure which can ensure operator safety throughout the stunning process.

Still other objects and advantages of the invention will in part be obvious and will in part be apparent from the specification.

The above and other objects, which will be apparent to those skilled in the art, are achieved in the present invention which is directed in one aspect to an enclosure for stunning animals for use in livestock/slaughterhouse operations comprising a floor for supporting the animal before and during stunning, and a plurality of upward-extending side walls around the floor for enclosing the animal before and during stunning. The enclosure may comprise a moveable stunner mount for securing a stunner, the stunner mount being positionable towards and away from the head of an animal in the enclosure. The stunner may comprise an electrical stunner or a pneumatic stunner.

In one or more embodiments, the enclosure may comprise a second moveable stunner mount for securing a second stunner, the second stunner mount being positionable towards and away from the head of an animal in the enclosure. The second stunner may comprise a pneumatic or an electrical stunner.

In some embodiments, the enclosure may further comprise a non-electrically conductive liner on a portion of the interior of the enclosure side walls to reduce current flow and grounding effects when the animal is electrically stunned while contacting the enclosure walls. The enclosure may comprise a non-electrically conductive liner on the floor of the enclosure. The enclosure floor liner may further comprise raised portions to reduce slipping by the animal when the animal is stunned. The enclosure may comprise a polymeric liner to reduce sound effects produced by the animal within the enclosure. The enclosure may comprise a liner on the portion of the interior of the enclosure sidewalls or floor which is non-electrically conductive comprising a polymeric liner, such that sound effects produced by the animal within the enclosure are reduced, and current flow and grounding effects when the animal is electrically stunned while contacting the enclosure walls is also reduced.

In other embodiments, the enclosure may further comprise a moveable rump panel between the side walls to contact the rear portion of the animal. The rump panel may be pivotable on a lower end thereof and moveable forward and downward toward the animal to move the animal forward in the enclosure before stunning. At least one actuator may move the rump panel towards and away from the animal.

In one or more embodiments, the enclosure may further comprise a moveable back-push panel between side walls to contact the back portion of the animal, the back-push panel being moveable downwardly towards and upwardly away from the animal and having a downward-facing concave surface when viewed along the length of the animal to secure the animal in the enclosure before stunning. The back-push panel concave surface may be constructed of polymeric material.

In some embodiments, the enclosure may further comprise a controller for monitoring stunning parameters in the enclosure during stunning operations. The stunning parameters may comprise stunner setpoint pressure, stunner supply pressure input, stun circuit electrical resistance, stun circuit electrical current, stun circuit electrical current duration, or any combination thereof. The enclosure may further comprise a weight load cell under the enclosure floor for weighing the animal before the animal is electrically stunned. The controller may receive data on the animal weight from the load cell, and may set stunning parameters based on the animal weight. The enclosure may further comprise an RFID scanner between the side walls for receiving the identification information of the animal before the animal is stunned. The controller may receive data on the animal from the RFID scanner such that the controller may set the stunning parameters based on the animal data. The enclosure may comprise a display, such that the controller and the display may monitor real-time data and control functions and operations of the stunner and enclosure before, during, and after stunning.

In one or more embodiments, the enclosure may further comprise a cradle adjacent the floor for receiving the animal after stunning. The cradle surface contacting the animal may comprise a polymeric covering for reducing noise as the animal is tipped out into the cradle after stunning. The cradle may further comprise at least one immobilization bar on the cradle for securing the animal therein. The cradle may be pivotable to three different positions for ease of operator slaughter.

In some embodiments, the enclosure may further comprise a winch and a safety-interlocking keyed system fitted to the winch for operator safety.

In one or more embodiments, the enclosure may further comprise a plurality of neck-holding panels between the side walls to converge around the neck portion of the animal. The neck-holding panels may be moveable towards and way from the animal and contact the neck of the animal to secure the animal's head in the enclosure before stunning. A pressure regulator may be included to control the amount of force exerted by the neck-holding panels to cushion and reduce excessive force on the neck of the animal. The neck-holding panels may be electrically insulated from the enclosure to prevent current flow and grounding effects when the animal is electrically stunned while contacting the neck-holding panels.

In other embodiments, the enclosure may further comprise a moveable panel between the side walls to hold a portion of the animal before stunning. At least one pneumatic cylinder actuator may move the panel toward and away from the animal. The enclosure may include an opening external to the enclosure, wherein the pneumatic cylinder actuator includes an intake for pressurized air and an exhaust for the pressurized air, and wherein the opening external to the enclosure exhausts pressurized air from the pneumatic cylinder actuator exhaust.

In one or more embodiments, the enclosure for stunning animals for use in livestock/slaughterhouse operations may comprise any combination of the aforementioned features.

The present invention also provides a method of stunning animals in livestock/slaughterhouse operations comprising providing an animal stunning enclosure for stunning animals for use in livestock/slaughterhouse operations comprising any combination of the aforementioned features of the enclosure. The method further comprises moving the animal into the enclosure and securing the animal's head in a position to receiving electrical or percussive stunning, stunning the animal, and removing the carcass of the animal from the enclosure.

In another aspect the present invention further provides a control system utilizing a computer program code for operating an enclosure for stunning animals for use in livestock/slaughterhouse operations. The enclosure comprises a floor for supporting the animal before and during stunning, a plurality of upward-extending side walls around the floor for enclosing the animal before and during stunning, a moveable stunner mount for securing a stunner, a weight load cell under the enclosure floor for weighing the animal before the animal is electrically stunned, and a controller for receiving data on the animal weight from the load cell. The controller may be adapted to set stunning parameters based on the animal weight. The computer program code may cause the controller to move the animal into the enclosure and secure the animal's head into a position to receive electrical or percussive stunning. The computer program code may cause the controller to stun the animal. The computer program code may cause the controller to remove the carcass of the animal from the enclosure.

The present invention further provides a method of stunning animals in livestock/slaughterhouse operations comprising providing an enclosure having a floor for supporting the animal before and during stunning, a plurality of upward-extending side walls around the floor for enclosing the animal before and during stunning, a moveable stunner mount for securing a stunner, the stunner mount being positionable toward and away from the head of an animal in the enclosure, and an electrical or percussive stunner secured in the stunner mount for stunning the animal. The method may further comprise moving the animal into the enclosure and securing the animal's head in a position to receive electrical or percussive stunning. The method may comprise applying the electrical or percussive stunner to the animal's head and stunning the animal, the same enclosure being used for both electrical or percussive stunning.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a perspective view of an animal stunning enclosure system according to the present invention.

FIG. 2 is a side perspective view of the animal stunning enclosure of FIG. 1.

FIG. 3 is a top plan view of the animal stunning enclosure of FIG. 1.

FIG. 4 is an enlarged perspective view of an interior portion of the animal stunning enclosure of FIG. 1.

FIG. 5 is a top plan view of an animal stunning enclosure, with loaded animal, according to the present invention.

FIG. 6 is a top plan view of an animal stunning enclosure, with loaded animal and winch system, according to the present invention.

FIG. 7 is a front view of an animal stunning enclosure with front side wall removed, depicting the loaded animal within the enclosure, according to the present invention.

FIG. 8 is a perspective view of the noise reducing exhaust system of the animal stunning enclosure according to the present invention.

FIG. 9 is an enlarged, bottom perspective view of the weight load cells under the box floor of the animal stunning enclosure according to the present invention.

FIG. 10 is a side, partial cross-sectional perspective view of the animal stunning enclosure according to the present invention, after an animal has been loaded during operation of the animal stunning enclosure.

FIG. 11 is a side, partial cross-sectional perspective view of FIG. 10, with rump panel removed.

FIG. 12 is an enlarged perspective view of an enclosure wall of the animal stunning enclosure with in-built RFID scanner according to the present invention.

FIG. 13 is a perspective view of the cradle of the animal stunning enclosure according to the present invention.

FIG. 14 is a rear view of the animal stunning enclosure and cradle according to the present invention, prior to operation of the enclosure and with the cradle in a first position.

FIG. 15 is a rear view of the animal stunning enclosure of FIG. 14, after operation of the enclosure and with the animal ejected from the enclosure and the cradle in a second position.

FIG. 16 is a top perspective view of a front portion the animal stunning enclosure according to the present invention, during stunning operations after an animal has been loaded and secured within the enclosure and prior to commencing electrical stunning operations.

### DESCRIPTION OF THE EMBODIMENT(S)

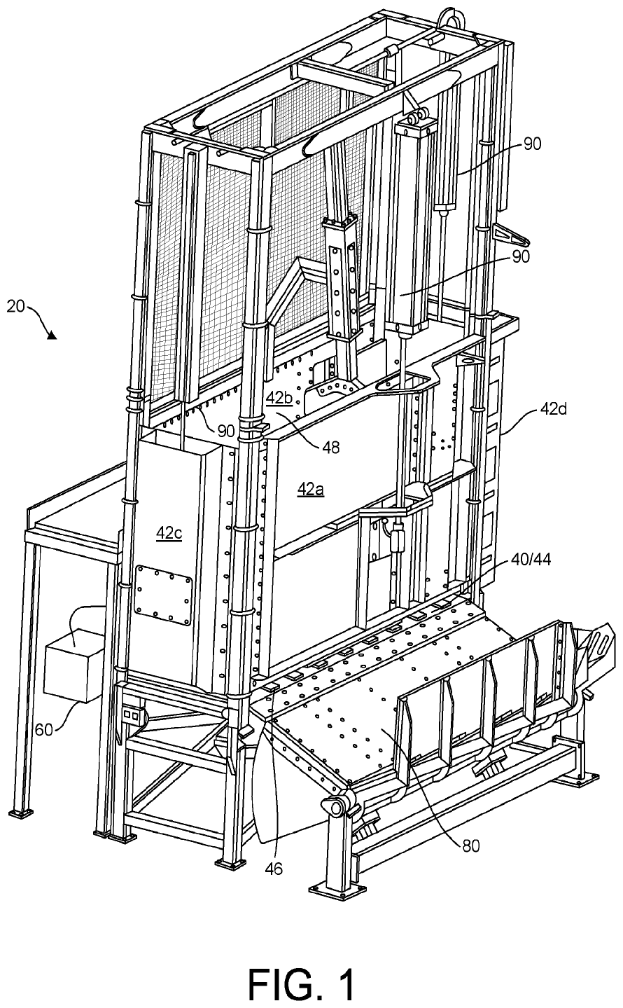

In describing the embodiment(s) of the present invention, reference will be made herein to FIGS. 1-16 of the drawings in which like numerals refer to like features of the invention.

There is shown in FIGS. 1-16 an embodiment of the enclosure for stunning animals of the present invention, for use in livestock/slaughterhouse operations. Enclosure 20 is also known as a “knocking box.” Enclosure 20 includes a floor 40 for supporting the animal 30 before and during stunning and a plurality of upward-extending side walls 42 around the floor 40 for enclosing the animal 30 before and during stunning. The floor 40 is shown elevated on posts, so the animal 30 would be led to walk up a ramp (not shown) to enter the enclosure 20. The floor may be horizontal, or may have a gentle slope outward, e.g., 5°, to assist in the disposal of the animal. Alternately, the floor may be set at ground level. Stairs and a walkway may be provided alongside side wall 42b of the enclosure 20 for the operator and/or animal handler, along with a cage structure above the side wall. Advantageously, the stairs and walkway provide an observation deck for the operator and/or animal handler. Thus, the operation of the enclosure may be monitored to ensure proper and humane administration of the stunning process. Likewise, the caged structure above the sidewall may be utilized to restrict access to the interior of the enclosure 20 and ensures safety of the operator and/or animal handler during the operation. Side wall 42c functions as a rear door which may be slideably moved upwards by operation of pneumatic cylinder actuator 90 to permit the animal 30 to enter the enclosure 20.

In addition to sliding side walls, enclosure 20 may include one or more different moveable panels and devices to position, hold and/or move the animal 30 before, during and after stunning. While the different moveable panels and devices of the present invention are described in combination with other features of the animal stunning enclosure, it should be understood that the any number of moveable panels and device described herein may be utilized with any of the other moveable panels and/or devices thereof. Thus, the embodiments of the present invention are meant to embrace any combination of moveable panels and/or devices which would position, hold, and/or move an animal before, during and after stunning such that the inventive concepts of the present invention may be so achieved.

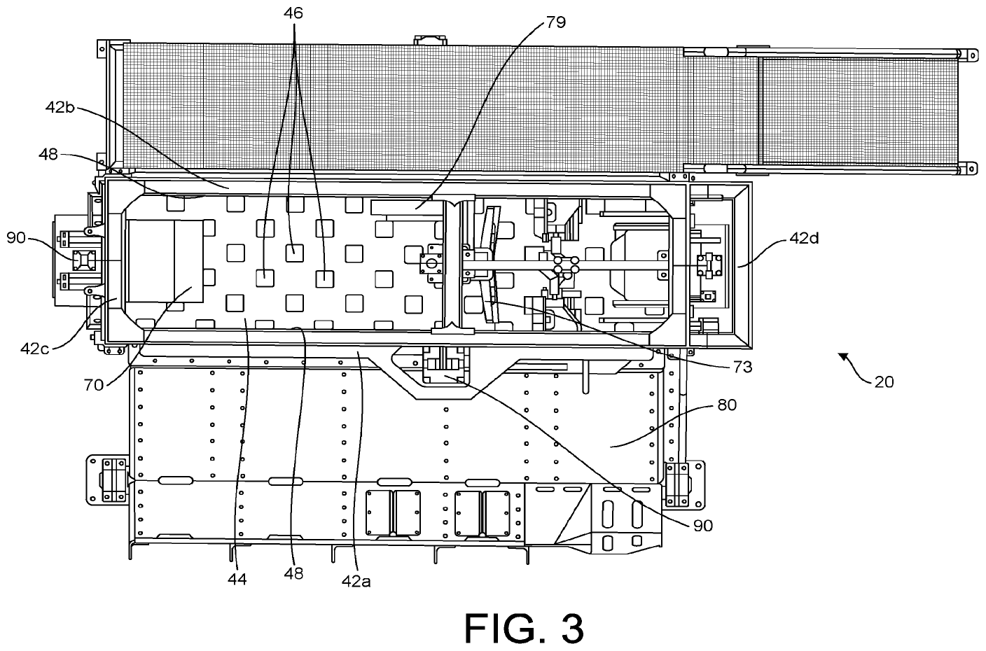

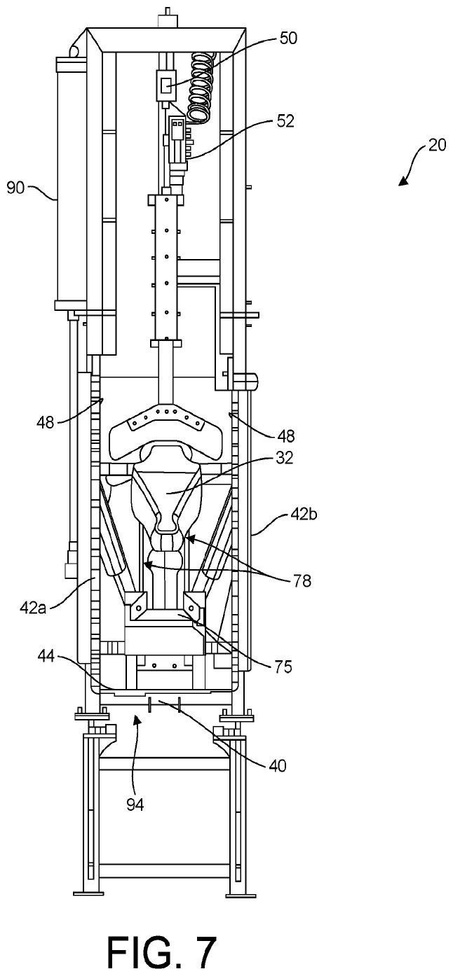

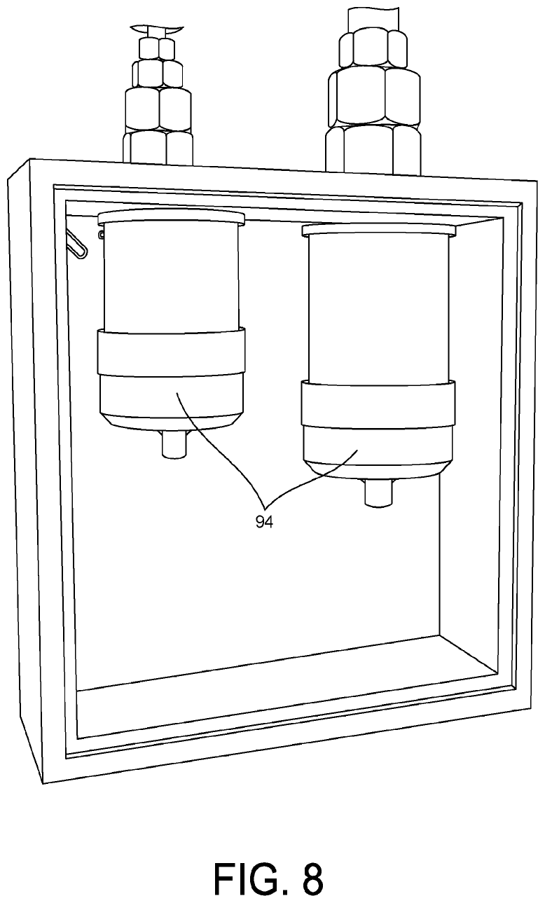

A moveable stunner mount 50 at the upper portion of the enclosure 20 secures a stunner 52, as shown in FIG. 7. The stunner mount 50 may be a moveable linear pipe trolley with a spring balancer for the load of the weight of stunner 52, so that the stunner is positionable by the operator toward and away from the head 32 of an animal 30 in the enclosure. After stunning, side wall 42a may be slideably moved upwards, by operation of pneumatic cylinder actuator 90 to permit the animal 30 to be removed from the enclosure 20, though other movement operations, including rotational movement, is not meant to be precluded. In some embodiments, side wall 42a may be slideably moved in a direction towards the rear or forward end of the enclosure 20. A moveable tipping panel 79, operable by pneumatic cylinder actuator 90, is provided in side wall 42b to push or tip the animal 30 carcass horizontally onto the cradle 80 after stunning (see FIGS. 3, 5, and 6).

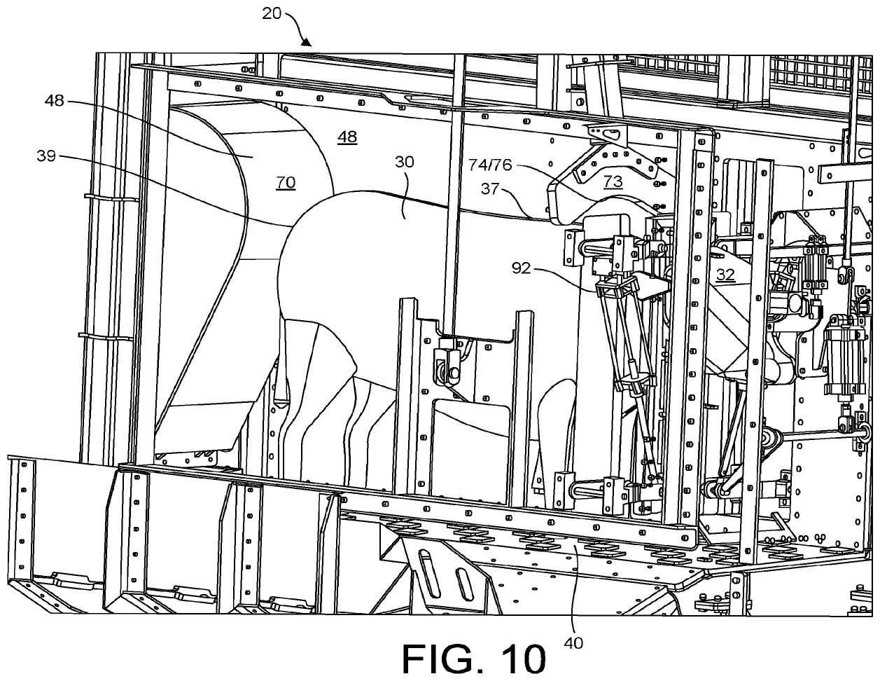

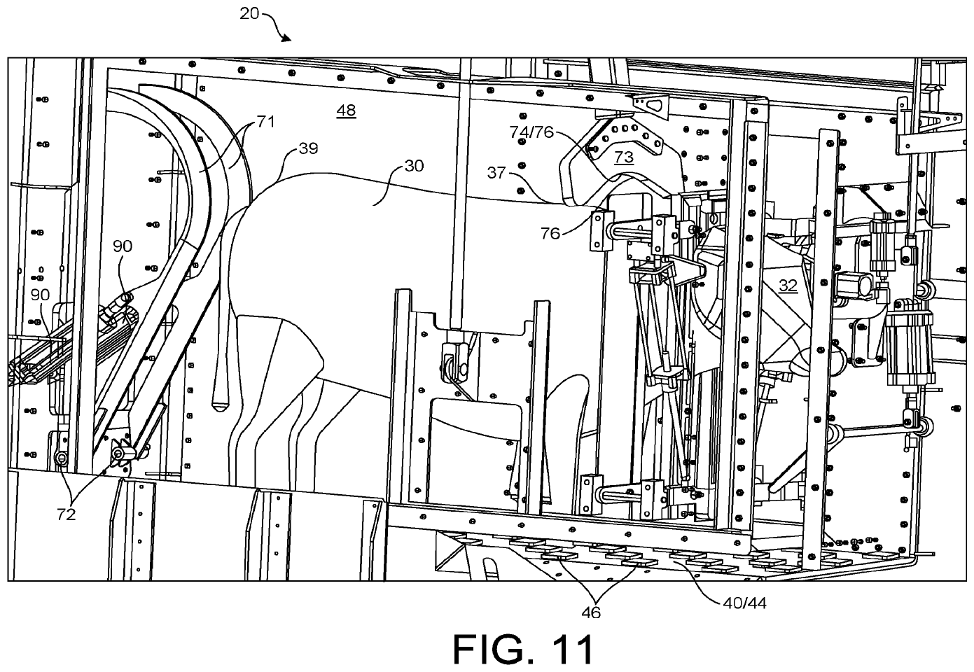

A moveable rump panel 70 (FIG. 10), mounted on rump panel frame members 71 (shown in FIG. 11 without panel 70), may be provided at the rear end of the enclosure between the side walls 42 to contact the rump portion 39 of the animal 30. At least one actuator, here shown as a pair of pneumatic cylinder actuators 90, may actuate to move the rump panel 70 toward and away from the animal 30. The rump panel 70 is pivotable around pivot axis 72 on a lower end thereof, so that the effect is that it is moveable forward and downward toward the animal 30 to move the animal 30 forward in the enclosure 20 before stunning.

As seen in the exemplary views of FIGS. 3, 5-6, and 10-11, a moveable back-push panel 73 may be disposed above and between the enclosure side walls 42 to contact the back portion 37 of the animal 30. The back-push panel 73 is alternately moveable by actuation of pneumatic cylinder actuator(s) 90 downwardly toward and upwardly away from the animal 30. The downward-facing lower surface 74 has a concave shape, when viewed along the length of the animal 30, to secure the body of animal 30 from moving upward in the enclosure 20 before stunning and to lessen the abrupt contact on the animal's back. Advantageously, due to the contoured shape of concave surface 74, unnecessary breaking of an animal's back is prevented upon moving concave surface into position to secure the animal back or after sudden movements of the animal secured by concave surface 74. Optionally, concave surface 74 may be angled acutely with respect to horizontal, rather than perpendicular, to further reduce harm to the animal. In some embodiments, the back-push panel and concave surface 74 may be made of a polymer such as nylon to cushion the back 37 of the animal, even further reduce the possibility of breakages to the back and unnecessary bruising to the animal secured thereto.

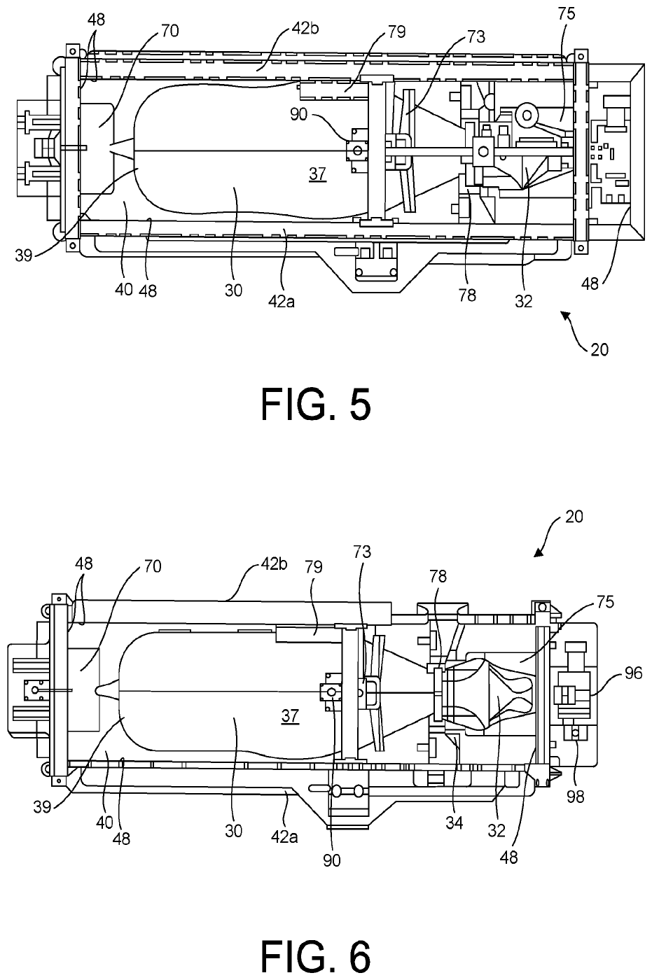

A plurality of neck-holding panels 78 (shown in FIGS. 5 and 6) may be provided between the side walls 42 to converge around the neck 36 portion of the animal 30. The neck-holding panels 78 are alternately moveable by operation and actuation of pneumatic cylinder actuators 90 toward and away from the animal 30 and contact the neck 36 of the animal 30 to secure the animal's head 32 in the enclosure 20 before stunning. A head table 75 also moves upward from below to support the animal's head 32 and lift the chin. A pressure regulator 92 disposed on neck hold 78 controls the amount of force exerted by the neck-holding panels to cushion and reduce excessive force on the neck 36 of the animal 30. The neck-holding panels, as well as the clevis pins and structure supporting them, may be electrically insulated with polymeric bushings from the enclosure 20 to prevent current flow and grounding effects when the animal 30 is electrically stunned while contacting the neck-holding panels.

A controller 60 in communication with the various components of the enclosure 20 may be provided at any desired location to monitor position and control movement of the stunner mount, stunner and the various panels of the enclosure and those contacting the animal 30. The controller 60 may include a display (not shown) for monitoring real-time data and controlling functions and operations of the stunner 52 and enclosure 20 before, during and after stunning. An interactive touch-screen display allows the operator to control all functionality from the operator position, with real-time updates.

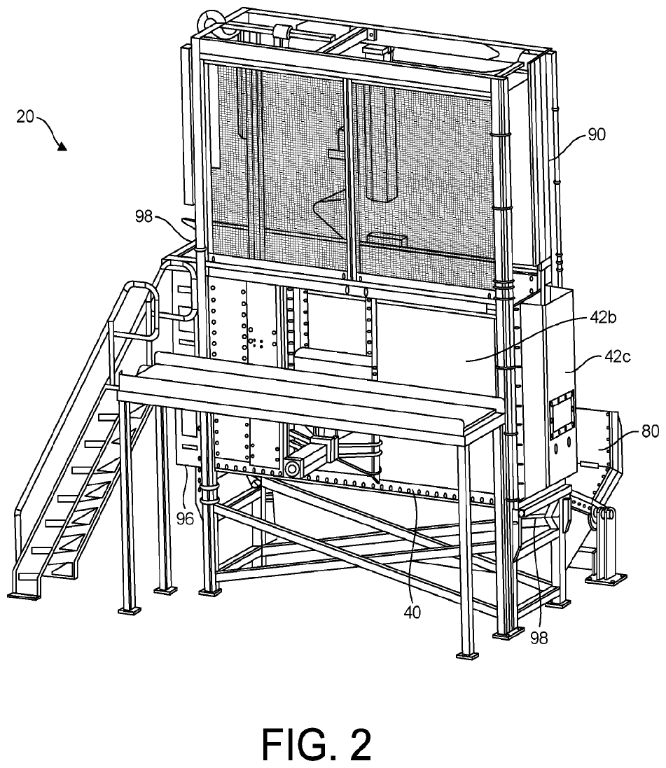

As depicted in FIGS. 2 and 6, a winch 96 is provided at the front of enclosure 20, and is accessible by the operator by slideably moving front side wall 42d upward by operation of pneumatic cylinder actuator 90. Winch 96 includes a cable (not shown), which may be extended through the length of the enclosure to the front side wall 42c or beyond and attached to a lame animal, to assist the animal into position in the enclosure by the operator powering the winch to retract the cable. A safety-interlock keyed system 98, under the operation of controller 60, is fitted to the winch 96 and to back and front side walls 42c, 42d, respectively, to prevent the walls from closing downwardly while the winch is in use, for safety at a time that the operator or the operator's limbs may be inside the enclosure.

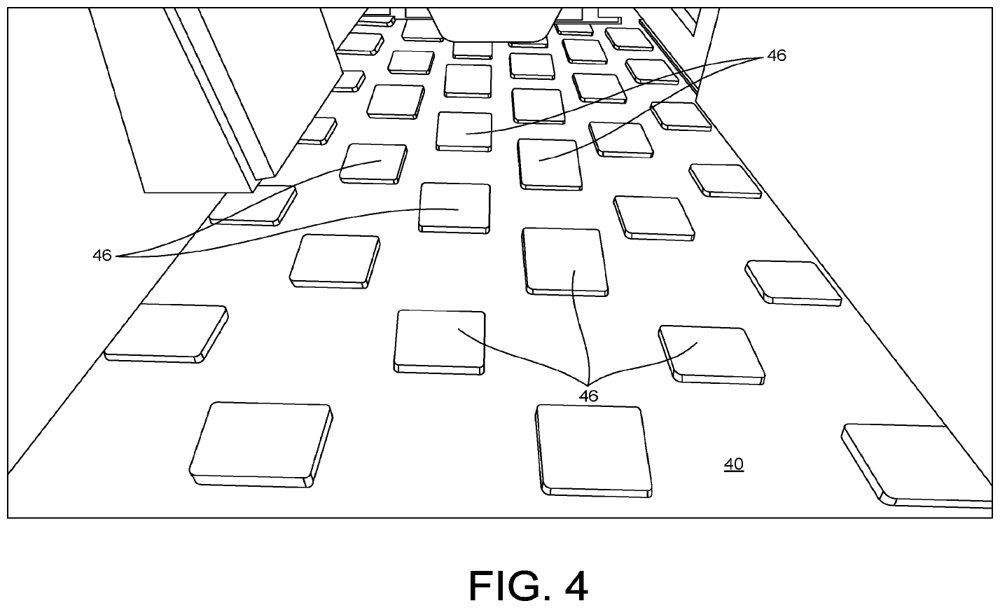

A non-electrically conductive plastic or other polymeric material liner 44, 48 may be provided on upper surface of the floor 40 and/or on the interior of the enclosure or box walls 42, respectively. Examples of such a liner 44, 48 are nylon and rubber. The embodiment shows a nylon liner 48 covering all or substantially all of the interior of the side walls 42, which reduces sound effects when the animal 30 kicks against the enclosure walls. Rump panel 70 may also be covered by a liner of nylon 48. When electrical stunning is employed, the liner 48 also reduces current flow and grounding (earth) effects when the animal 30 contacts the enclosure walls 42 during electrical stunning. The liner 48 may cover less than all of the interior wall 42 surfaces, for example, only those areas to be contacted by the animal's body or hoofs. On the upper surface of the floor 40, a vulcanized rubber matting with alternating, slightly raised portions 46 to prevent the animal 30 from slipping, here exemplified by raised square shapes (as shown in FIGS. 3 and 4). As a result, the enclosure 20 is relatively quiet, by reducing the noise of the animal 30 kicking out at the walls 42. This reduces or eliminates vocalization and stress of the animals from noise spooking themselves and the next animals waiting in the race to be processed.

Additional noise reduction to the animals is achieved by the placement externally to the enclosure 20 of the exhausts 94 of the pneumatic cylinder actuators 90 moving the enclosure panels and of the pneumatic control valves, depicted in FIG. 8. The exhausts 94 are piped externally of the enclosure 20, for example, below the floor 40, by one or more exhaust manifolds from the actuators and valves.

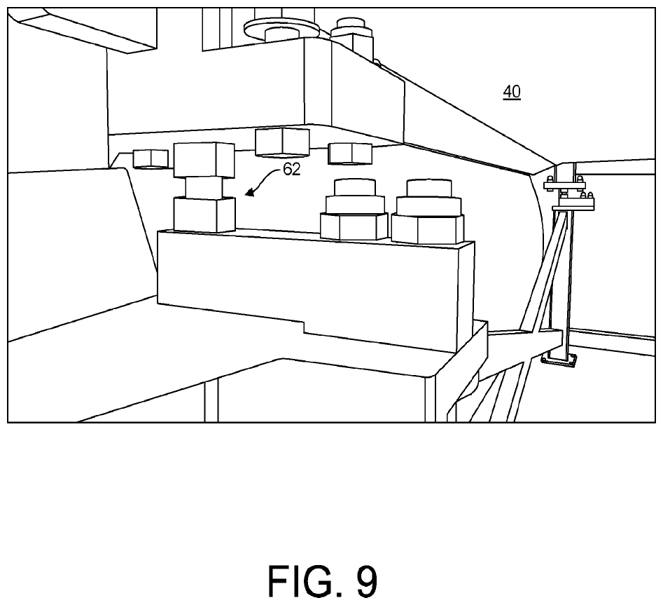

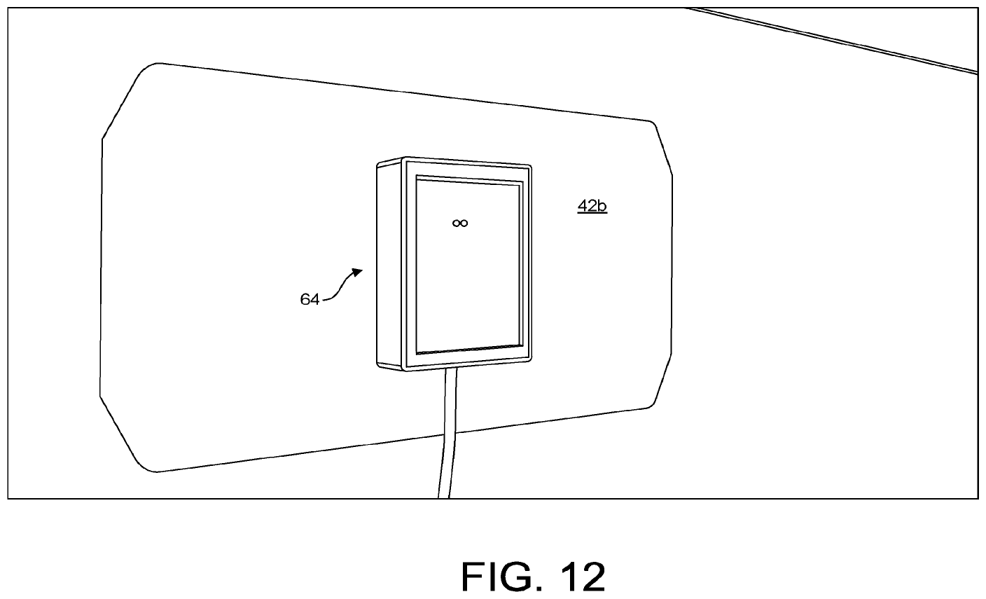

The enclosure 20 may include one or more weight load cells 62 under the box floor 40, like those seen in exemplary FIG. 9, to allow the cow to be instantly weighed prior to slaughter. An in-built RFID scanner 64 between the enclosure walls 42 (shown in FIG. 12) reads identification data from the animal's RFID ear tag 34. The animal identification and weight allow data collection regarding the efficacy of each (electric or pneumatic) stun and tracking for audit or review purposes. The use of this data permits controller 60 to select the most appropriate stunning parameter setting for the particular sized animal 30 being stunned. The controller 60 may additionally monitor stun circuit electrical resistance of the separate components in the enclosure during electrical stunning, as an additional level of operator safety.

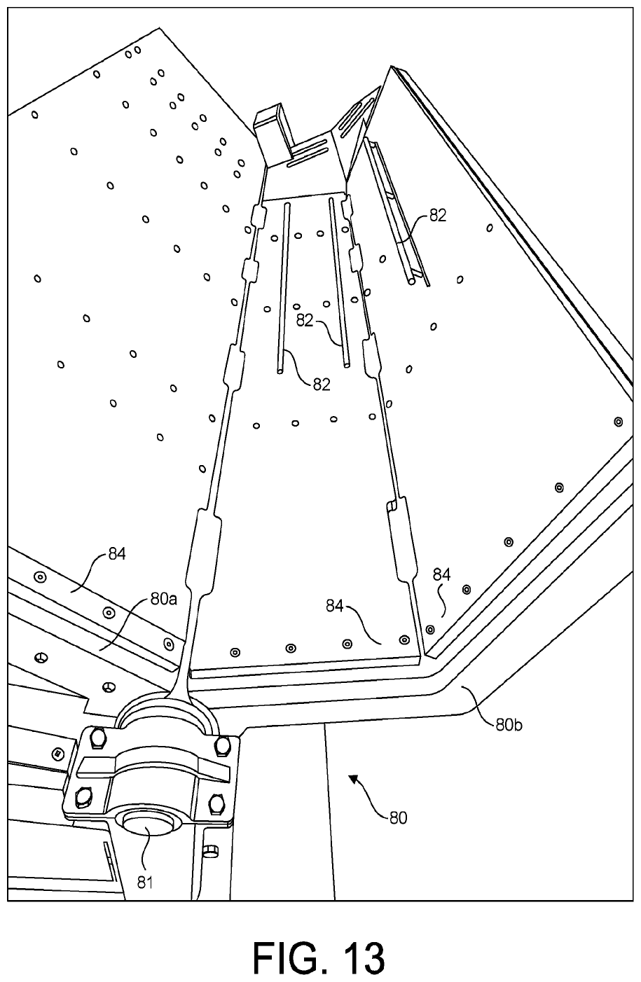

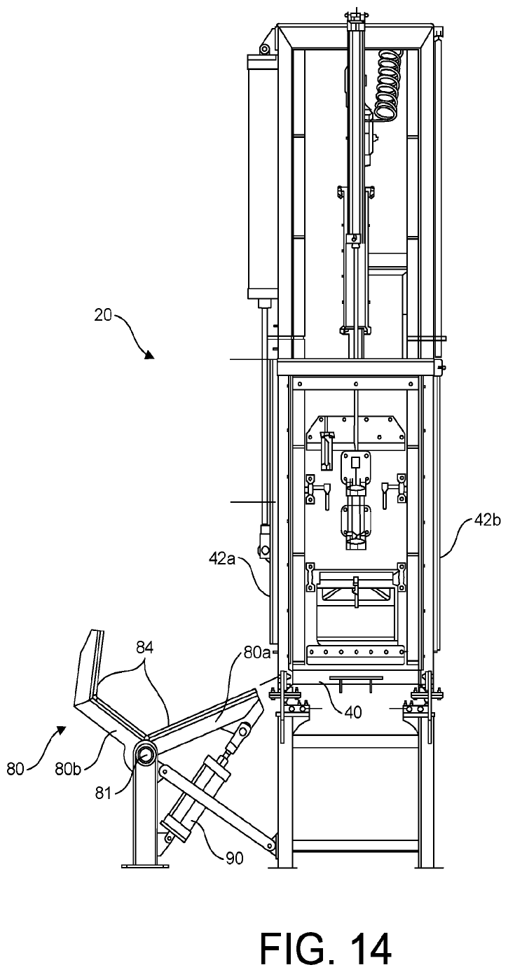

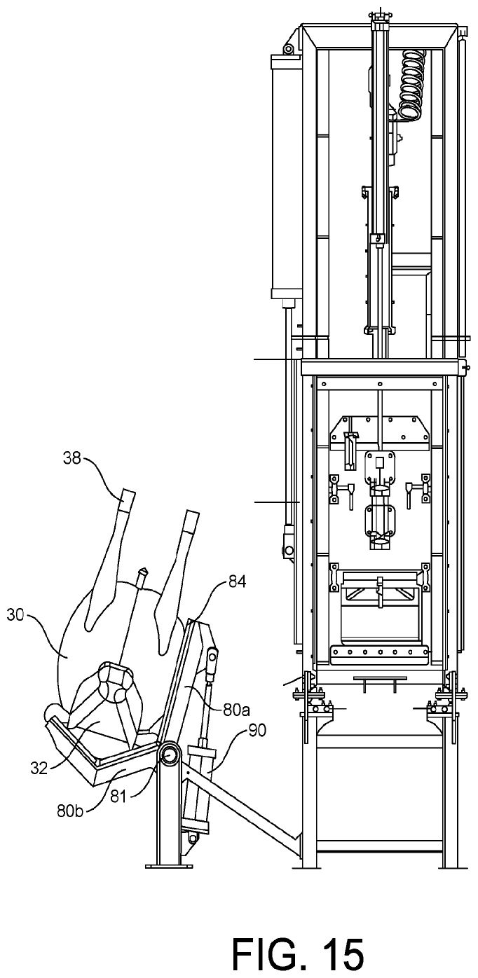

A cradle 80 may be provided adjacent the floor 40 for receiving the animal 30 after stunning, by sliding side wall 42a upward and pushing animal 30 out using tipping panel 79 onto the cradle. The cradle includes on one side flat portion 80a, which in receiving position A (FIG. 14) is slightly below floor 40 and adjacent side wall 42, and on the opposite side a V-shaped portion 80b. For sliding the animal from the box, floor 40 may be angled downward toward cradle 80, for example at an angle a from horizontal of up to about 5-10°. Between cradle sides 80a and 80b is cradle pivot axis 81, around which the cradle pivots upon action of pneumatic cylinder actuator positioned between the cradle base and the underside cradle flat portion 80a. The cradle surface contacting the animal 30 on both portions 80a, 80b may have a polymeric covering 84, such as the aforedescribed nylon layer, for reducing noise as the animal 30 is tipped out onto the cradle 80 after stunning. As shown in FIG. 13, cylindrical immobilizer bars 82 are positioned and extend slightly above and along a portion of the length of the surface of cradle V portion 80b, with two spaced apart bars 82 on one of the V segments, and one bar 82 on the other V segment. The one or more immobilization bars 82 stiffen the animal and prevent the animal 30 from kicking out or “paddling” in the cradle 80, so that the operator can safely attach the leg shackle without being kicked. The cradle 80 is pivotable to three different positions for ease of animal carcass reception, operator slaughter and carcass removal. In addition to position A, cradle 80 may be rotated by actuator 90 to position B (FIG. 15) where the animal's hooves 38 are generally upward, for operator processing, e.g., for halal throat cutting purposes, and then rotated further to a position where the animal 30 can be chained and hoisted or rolled off cradle V portion 80b (not shown). The cradle 80 structure and operation ensure the animal's throat is presented in the most open way to allow the operator to apply the cut, and is the best way for the operator to shackle the animal.

The sequence of operation for using the enclosure 20 in stunning animals in livestock/slaughterhouse operations includes opening the back door wall by sliding side wall 42c upward and walking the animal 30 into floor 40 of the enclosure 20 (or pulling the animal in using winch 96), and then closing the door, initially reading the RFID ear tag 34 of the animal 30 and logging its weight by load cell 62 under the floor. The enclosure 20 then performs a rump push by rump panel 70, a shoulder push by back-push panel 73, a neck hold by panels 78 and a chin lift by the head table 75 to place animal 30 in proper position. A pressure regulator 92 on the neck hold 78 prevents excessive force being placed on the animal's neck 36. The cradle 80 is put into position A, and the animal 30 is ready to stun.

In the case of percussive or pneumatic stunning, there may be employed a stunner of the types disclosed in U.S. Pat. Nos. 6,135,871 and 9,743,678 owned by the instant applicant, the disclosures of which are hereby incorporated by reference. The stunner 52 may be hand-held by an operator, but may also be mounted on positionable stunner mount 50 which may be moved toward and away from the animal's head 32 held by the neck holder 78 by command of controller 60.

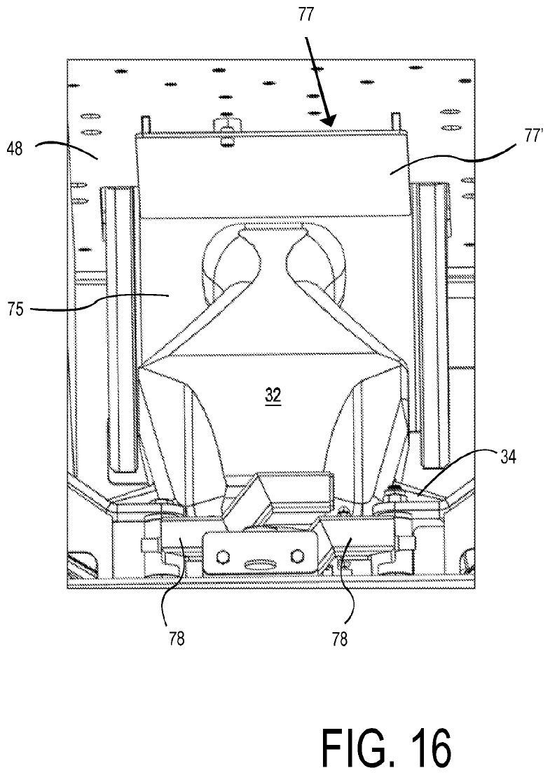

In the case of electric stunning, the current is applied through three (3) points, the two (2) neck-holding panels and a stunner paddle in front of the animal's head. During stunning, nozzles (not shown) may spray water at these three points before and during the stun cycle. As seen in FIG. 16, upon loading animal within the enclosure and actuating neck-holding panels 78 to engage the animal's neck 36 the animal's head 32 is proximate sidewall liner 48 towards the enclosure's forward portion. Head table 75 may subsequently engage, placing animal head 32 in proper position before stunning operation. Moveable stunner mount 77 comprising a stunner paddle 77′ may then extend to a position which contacts the front of the animal's head. Current may then be applied through neck-holding panels 78 and stunner paddle 77′ via stunner mount 77.

In either percussive stunning or electrical stunning operations, the enclosure may comprise weight load cell(s) 62 to provide necessary data to controller 60, which may select the most appropriate stunning parameter setting for the particular sized animal 30 being stunned. In the case of percussive stunning, controller 60 may select parameters including stunner setpoint pressure, stunner supply pressure input, and the like. After stunning, the controller may collect additional data such as the stunner pressure output, which can be used to ensure effective stunning and proper maintenance of the stunner is achieved. In the case of electrical stunning, such parameters may include the electrical current, duration of time to supply the current, and the like. The controller 60 may additionally monitor stun circuit electrical resistance of the separate components in the enclosure during electrical stunning, as an additional level of operator safety. In addition, the controller 60 may further communicate with RFID scanner 64, which may link the data collected during stunning to the particular RFID ear tag 34 of the animal within the enclosure. Thus, controller 60 may provide data collection regarding efficacy of any stunning attempt (electric or pneumatic) to provide tracking for audit or review purposes, and ensures safe, effective, and humane disabling of an animal within the enclosure.

After the stunning is successfully performed, the animal 30 is tipped outward from the enclosure onto the cradle 80 in position A, and then rotated to or through position B with the animal's back 37 between the walls of the cradle V potion 80b and the animal's legs 38 in an upward direction. The cradle ultimately rotates to the final position where the animal 30 carcass is them transferred off of the cradle for subsequent processing.

Dual functionality of the enclosure of the present invention allows the operator to alternate between electric or percussive stunning as desired.

An embodiment of the controller 60 or other control system for the present invention may take the form of a hardware embodiment that uses software (including firmware, resident software, micro-code, etc.). Furthermore, an embodiment may take the form of a computer program product on a tangible computer-usable storage medium having computer-usable program code embodied in the medium. A memory device or memory portion of the control system can form the medium. Computer program code or firmware to carry out an embodiment of the present disclosure could also reside on optical or magnetic storage media, especially while being transported or stored prior to or incident to the loading of the computer program code or firmware into the control system. This computer program code or firmware can be loaded, as an example, by connecting a computer system to the programming interface.

It should be appreciated and understood that the present invention may be embodied as systems, methods, apparatus, computer readable media, non-transitory computer readable media and/or computer program products. The present invention may take the form of an entirely hardware embodiment, an entirely software embodiment (including firmware, resident software, micro-code, etc.) or an embodiment combining software and hardware aspects that may all generally be referred to herein as a “circuit,” “module,” “system,” or “processor” configured to practice the method(s) or system(s) of the invention. The present invention may take the form of a computer program product embodied in one or more computer readable medium(s) having computer readable program code embodied thereon.

One or more computer readable medium(s) may be utilized, alone or in combination. The computer readable medium may be a computer readable storage medium or a computer readable signal medium. A suitable computer readable storage medium may be, for example, but not limited to, an electronic, magnetic, optical, electromagnetic, infrared, or semiconductor system, apparatus, or device, or any suitable combination of the foregoing. Other examples of suitable computer readable storage medium would include, without limitation, the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. A suitable computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Scala, Ruby, Python, Smalltalk, C++ or the like and conventional procedural programming languages, such as the “C” programming language or similar programming languages. The program code may execute entirely on the user's computing device (such as, a computer), partly on the user's computing device, as a stand-alone software package, partly on the user's computer device and party on a remote computing device or entirely on the remote computing device or server. In the latter scenario, the remote computing device may be connected to the user's computing device through any type of network, including a local area network (LAN), a wide area network (WAN), or a wireless local area network (WLAN), or the connection may be made to an external computing device (for example, through the Internet using an Internet Service Provider).

The methods of operation of the present invention may be implemented by computer program instructions. The method steps include those described above in using the enclosure 20 in stunning animals in livestock/slaughterhouse operations. These computer program instructions may be provided to a processor of a general-purpose computing device (such as, a computer), special purpose computing device, or other programmable data processor or processing apparatus to produce a machine, such that the instructions, which execute via the processor of the computing device or other programmable data processing apparatus, create means for implementing the functions/acts specified in the flowchart and/or block diagram block or blocks.

These computer program instructions may also be stored in a computer readable medium that can direct a computing device, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computing device or other programmable apparatus provide processes for implementing the functions/acts specified in a flowchart and/or block diagram block or blocks.

Thus, the present invention provides an enclosure and method of using the enclosure for stunning and processing cows or other cattle which has one or more of the following advantages: 1) reduction in preemptively agitating and alerting the animal to be stunned so as to cause the animal to move its body or raise its head to a position which causes pain to the animal or prevents proper and humane administration of the stunning to instantly achieve disabling of the animal; 2) efficiently monitoring and controlling the entire stunning process, including monitoring of animal weight to collect data for improvement of the stunning process; 3) efficiently disposing of the carcass after stunning without unnecessarily bruising the carcass and adversely affecting the quality of the meat; and/or 4) ensuring operator safety throughout the process.

While the present invention has been particularly described, in conjunction with one or more specific embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. An enclosure for stunning animals for use in livestock/slaughterhouse operations comprising:
a floor for supporting the animal before and during stunning;
a plurality of upward-extending side walls around the floor for enclosing the animal before and during stunning;
a moveable stunner mount for securing a stunner, the stunner mount being positionable toward and away from the head of an animal in the enclosure; and
a non-electrically conductive liner on the interior of the enclosure side walls to reduce current flow and grounding effects when the animal is electrically stunned while contacting the enclosure walls.

2. The enclosure of claim 1, further comprising a non-electrically conductive liner on the floor of the enclosure, the floor liner having raised portions to reduce slipping by the animal before the animal is stunned.

3. The enclosure of claim 1, further comprising a moveable rump panel between the side walls to contact the rear portion of the animal, the rump panel being pivotable on a lower end thereof and moveable forward and downward toward the animal to move the animal forward in the enclosure before stunning, and at least one actuator to move the rump panel toward and away from the animal.

4. The enclosure of claim 1, wherein the stunner comprises an electrical stunner or a pneumatic stunner.

5. The enclosure of claim 4, further comprising a second moveable stunner mount for securing a second stunner, the second stunner mount being positionable toward and away from the head of an animal in the enclosure, the second stunner comprising a pneumatic stunner or an electrical stunner.

6. The enclosure of claim 1, wherein the non-electrically conductive liner comprises a polymeric liner to reduce sound effects produced by the animal within the enclosure.

7. The enclosure of claim 1, further comprising a moveable back-push panel between the side walls to contact the back portion of the animal, the back-push panel being moveable downwardly toward and upwardly away from the animal and having a downward-facing concave surface when viewed along the length of the animal to secure the animal in the enclosure before stunning.

8. (canceled)

9. The enclosure of claim 1, further comprising a controller for monitoring stunning parameters in the enclosure during stunning operations, said parameters comprising at least one of stunner setpoint pressure, stunner supply pressure input, stun circuit electrical resistance, stun circuit electrical current, stun circuit electrical current duration, or any combination thereof.

10. The enclosure of claim 9, further comprising a weight load cell under the enclosure floor for weighing the animal before the animal is electrically stunned, and wherein the controller may receive data on the animal weight from the load cell, the controller adapted to set stunning parameters based on the animal weight.

11. The enclosure of claim 9, further comprising an RFID scanner between the side walls for receiving the identification information of the animal before the animal is stunned, and wherein the controller may receive data on the animal from the RFID scanner, the controller adapted to set stunning parameters based on the animal data.

12. (canceled)

13. The enclosure of claim 1, further comprising a cradle adjacent the floor for receiving the animal after stunning, the cradle surface contacting the animal having a polymeric covering for reducing noise as the animal is tipped out onto the cradle after stunning.

14. The enclosure of claim 13, wherein the cradle further comprises at least one immobilization bar on the cradle for securing the animal therein.

15. The enclosure of claim 13, wherein the cradle is pivotable to three different positions for ease of operator slaughter.

16. The enclosure of claim 1, further comprising a winch and a safety-interlocking keyed system fitted to the winch for operator safety.

17. The enclosure of claim 1, further comprising a plurality of neck-holding panels between the side walls to converge around the neck portion of the animal, the neck-holding panels being moveable toward and away from the animal and contact the neck of the animal to secure the animal's head in the enclosure before stunning, and a pressure regulator controlling the amount of force exerted by the neck-holding panels to cushion and reduce excessive force on the neck of the animal.

18. The enclosure of claim 17, wherein the neck-holding panels are electrically insulated from the enclosure to prevent current flow and grounding effects when the animal is electrically stunned while contacting the neck-holding panels.

19. The enclosure of claim 1, further comprising a moveable panel between the side walls to hold a portion of the animal before stunning, at least one pneumatic cylinder actuator to move the panel toward and away from the animal, and an opening external to the enclosure, wherein the pneumatic cylinder actuator includes an intake for pressurized air and an exhaust for the pressurized air, and wherein the opening external to the enclosure exhausts pressurized air from the pneumatic cylinder actuator exhaust.

20-91. (canceled)

92. An enclosure for stunning animals for use in livestock/slaughterhouse operations comprising:
a floor for supporting the animal before and during stunning;
a plurality of upward-extending side walls around the floor for enclosing the animal before and during stunning;
a moveable stunner mount for securing a stunner, the stunner mount being positionable toward and away from the head of an animal in the enclosure;
a moveable back-push panel between the side walls to contact the back portion of the animal, the back-push panel being moveable downwardly toward and upwardly away from the animal and having a downward-facing concave surface when viewed along the length of the animal to secure the animal in the enclosure before stunning.

93-94. (canceled)

95. The enclosure of claim 92, further comprising a moveable rump panel between the side walls to contact the rear portion of the animal, the rump panel being pivotable on a lower end thereof and moveable forward and downward toward the animal to move the animal forward in the enclosure before stunning, and at least one actuator to move the rump panel toward and away from the animal.

96. (canceled)

97. The enclosure of claim 92, further comprising a second moveable stunner mount for securing a second stunner, the second stunner mount being positionable toward and away from the head of an animal in the enclosure, the second stunner comprising a pneumatic stunner or an electrical stunner.

98. The enclosure of claim 92, wherein the back-push panel concave surface is constructed of polymeric material.

99-106. (canceled)

107. The enclosure of claim 92, further comprising a plurality of neck-holding panels between the side walls to converge around the neck portion of the animal, the neck-holding panels being moveable toward and away from the animal and contact the neck of the animal to secure the animal's head in the enclosure before stunning, and a pressure regulator controlling the amount of force exerted by the neck-holding panels to cushion and reduce excessive force on the neck of the animal.

108. The enclosure of claim 107, wherein the neck-holding panels are electrically insulated from the enclosure to prevent current flow and grounding effects when the animal is electrically stunned while contacting the neck-holding panels.

109. The enclosure of claim 92, further comprising at least one pneumatic cylinder actuator to move the back-push panel toward and away from the animal, the pneumatic cylinder actuator having an intake for pressurized air and an exhaust for the pressurized air, and an opening external to the enclosure for exhausting pressurized air from the pneumatic cylinder actuator exhaust.

110-181. (canceled)

182. An enclosure for stunning animals for use in livestock/slaughterhouse operations comprising:
a floor for supporting the animal before and during stunning;
a plurality of upward-extending side walls around the floor for enclosing the animal before and during stunning;
a moveable stunner mount for securing a stunner, the stunner mount being positionable toward and away from the head of an animal in the enclosure; and
a cradle adjacent the floor for receiving the animal after stunning, the cradle surface contacting the animal having a polymeric covering for reducing noise as the animal is tipped out onto the cradle after stunning.

183. The enclosure of claim 182, wherein the cradle comprises at least one immobilization bar on the cradle for securing the animal therein.

184. The enclosure of claim 182, wherein the cradle is pivotable to three different positions for ease of operator slaughter.

185-220. (canceled)
